(19) United States
(12) Patent Application Publication
(10) Pub. No.: US 2024/0079685 A1
(43) Pub. Date: Mar. 7, 2024

(54) THERMAL BARRIERS FOR VENTING AREAS OF TRACTION BATTERY PACKS

(71) Applicant: FORD GLOBAL TECHNOLOGIES, LLC, Dearborn, MI (US)

(72) Inventor: Michael E. REIBLING, Sterling Heights, MI (US)

(21) Appl. No.: 18/298,497

(22) Filed: Apr. 11, 2023

Related U.S. Application Data
(60) Provisional application No. 63/403,445, filed on Sep. 2, 2022.

(51) Int. Cl. H01M 10/658; H01M 50/249; H01M 50/289

(52) U.S. Cl. CPC H01M 10/658; H01M 50/249; H01M 50/289; H01M 2220/20

(57) ABSTRACT

Thermal barriers are provided for traction battery packs. An exemplary thermal barrier may be positioned within a venting passageway of a traction battery pack. The thermal barrier may thermally protect upper and/or lower enclosure structures and may substantially prevent thermal energy from moving from cell stack-to-cell stack during a battery thermal event.

### CROSS-REFERENCE TO RELATED APPLICATIONS

This disclosure claims priority to U.S. Provisional Application No. 63/403,445, which was filed on Sep. 2, 2022 and is incorporated herein by reference.

### TECHNICAL FIELD

This disclosure relates generally to traction battery packs, and more particularly to thermal barriers that may be positioned within areas of the traction battery pack that are configured for capturing battery cell vent byproducts.

### BACKGROUND

Electrified vehicles include a traction battery pack for powering electric machines and other electrical loads of the vehicle. The traction battery pack includes a plurality of battery cells and various other battery internal components that support electric vehicle propulsion.

### SUMMARY

A traction battery pack according to an exemplary aspect of the present disclosure includes, among other things, a first cross-member beam that supports a first cell stack, a second cross-member beam that supports a second cell stack, a venting passageway disposed between the first cross-member beam and the second cross-member beam, and a thermal barrier arranged within the venting passageway.

In a further non-limiting embodiment of the foregoing traction battery pack, the first cross-member beam and the second cross-member beam establish a cross-member assembly arranged between the first cell stack and the second cell stack.

In a further non-limiting embodiment of either of the foregoing traction battery packs, the first cell stack is supported between the first cross-member beam and a third cross-member beam, and the second cell stack is supported between the second cross-member beam and a fourth cross-member beam.

In a further non-limiting embodiment of any of the foregoing traction battery packs, the thermal barrier is positioned to interface with an upper enclosure structure of the traction battery pack at a vertically upper side of the venting passageway.

In a further non-limiting embodiment of any of the foregoing traction battery packs, an adhesive is disposed between the upper enclosure structure and the thermal barrier.

In a further non-limiting embodiment of any of the foregoing traction battery packs, a second thermal barrier is positioned to interface with a lower enclosure structure of the traction battery pack at a vertically lower side of the venting passageway.

In a further non-limiting embodiment of any of the foregoing traction battery packs, the thermal barrier is positioned to interface with a lower enclosure structure of the traction battery pack at a vertically lower side of the venting passageway.

In a further non-limiting embodiment of any of the foregoing traction battery packs, an adhesive is disposed between the lower enclosure structure and the thermal barrier.

In a further non-limiting embodiment of any of the foregoing traction battery packs, the thermal barrier includes a thermally resistant material.

In a further non-limiting embodiment of any of the foregoing traction battery packs, the thermally resistant material includes mica, aerogel materials, or refractory ceramic fibers.

In a further non-limiting embodiment of any of the foregoing traction battery packs, a second thermal barrier is arranged between the first cell stack or the second cell stack and an upper enclosure structure of the traction battery pack.

In a further non-limiting embodiment of any of the foregoing traction battery packs, an adhesive is disposed between the upper enclosure structure and the second thermal barrier.

A traction battery pack according to another exemplary aspect of the present disclosure includes, among other things, an enclosure assembly establishing an interior area, a first cell stack housed within the interior area and including a first cross-member beam, a second cell stack housed within the interior area and including second cross-member beam, a venting passageway disposed between the first cross-member beam and the second cross-member beam, a first thermal barrier arranged within the venting passageway, and a second thermal barrier arranged over top of the first cell stack or the second cell stack.

In a further non-limiting embodiment of the foregoing traction battery pack, the first thermal barrier establishes a first sealed interface relative to an upper enclosure structure of the traction battery pack at a vertically upper side of the venting passageway.

In a further non-limiting embodiment of either of the foregoing traction battery packs, an adhesive is disposed between the upper enclosure structure and the first thermal barrier.

In a further non-limiting embodiment of any of the foregoing traction battery packs, the second thermal barrier establishes a second sealed interface relative to the upper enclosure structure.

In a further non-limiting embodiment of any of the foregoing traction battery packs, an adhesive is disposed between the upper enclosure structure and the second thermal barrier.

In a further non-limiting embodiment of any of the foregoing traction battery packs, each of the first thermal barrier and the second thermal barrier includes a thermally resistant material.

In a further non-limiting embodiment of any of the foregoing traction battery packs, the thermally resistant material includes mica, aerogel materials, or refractory ceramic fibers.

In a further non-limiting embodiment of any of the foregoing traction battery packs, a third thermal barrier is arranged within the venting passageway.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates an electrified vehicle.

FIG. 2 is an exploded perspective view of a traction battery pack for an electrified vehicle.

FIG. 3 is a cross-sectional view through section 3-3 of FIG. 2 and illustrates a thermal barrier positioned relative to an upper enclosure structure of a traction battery pack.

FIG. 4 illustrates a thermal barrier positioned relative to a lower enclosure structure of a traction battery pack.

FIG. 5 illustrates a thermal barrier positioned relative to both an upper enclosure structure and a lower enclosure structure of a traction battery pack.

FIG. 6 illustrates another thermal barrier positioned between a cell stack and an upper enclosure structure of a traction battery pack.

FIG. 7 is a cross-sectional view of a cell stack of a traction battery pack.

### DETAILED DESCRIPTION

This disclosure details thermal barriers for traction battery packs. An exemplary thermal barrier may be positioned within a venting passageway of a traction battery pack. The thermal barrier may thermally protect upper and/or lower enclosure structures and may substantially prevent thermal energy from moving from cell stack-to-cell stack during a battery thermal event. These and other features are discussed in greater detail in the following paragraphs of this detailed description.

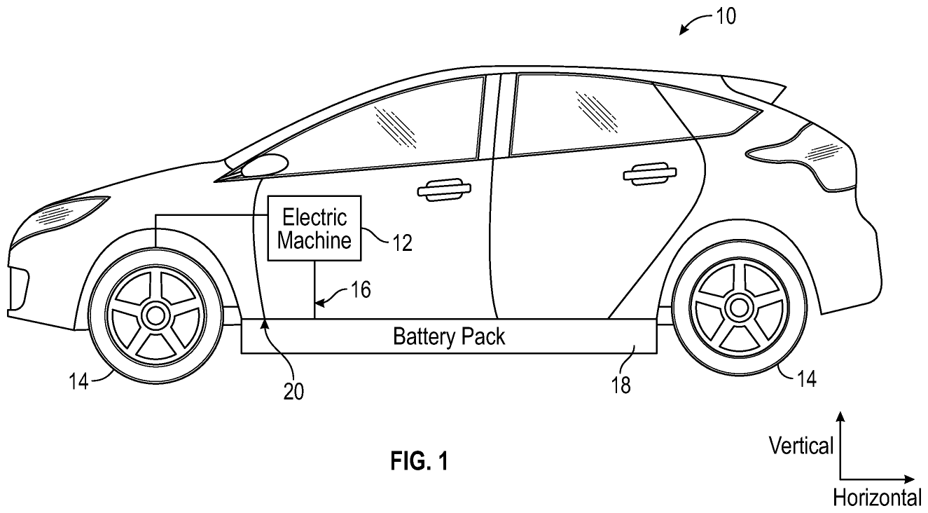

FIG. 1 schematically illustrates an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEV's), fuel cell vehicles, etc. Therefore, although not specifically shown in the exemplary embodiment, the powertrain of the electrified vehicle 10 could be equipped with an internal combustion engine that can be employed either alone or in combination with other power sources to propel the electrified vehicle 10.

In the illustrated embodiment, the electrified vehicle 10 is depicted as a car. However, the electrified vehicle 10 could alternatively be a sport utility vehicle (SUV), a van, a pickup truck, or any other vehicle configuration. Although a specific component relationship is illustrated in the figures of this disclosure, the illustrations are not intended to limit this disclosure. The placement and orientation of the various components of the electrified vehicle 10 are shown schematically and could vary within the scope of this disclosure. In addition, the various figures accompanying this disclosure are not necessarily drawn to scale, and some features may be exaggerated or minimized to emphasize certain details of a particular component or system.

In the illustrated embodiment, the electrified vehicle 10 is a full electric vehicle propelled solely through electric power, such as by one or more electric machines 12, without assistance from an internal combustion engine. The electric machine 12 may operate as an electric motor, an electric generator, or both. The electric machine 12 receives electrical power and can convert the electrical power to torque for driving one or more wheels 14 of the electrified vehicle 10.

A voltage bus 16 may electrically couple the electric machine 12 to a traction battery pack 18. The traction battery pack 18 is an exemplary electrified vehicle battery. The traction battery pack 18 may be a high voltage traction battery pack assembly that includes a plurality of battery cells capable of outputting electrical power to power the electric machine 12 and/or other electrical loads of the electrified vehicle 10. Other types of energy storage devices and/or output devices could alternatively or additionally be used to electrically power the electrified vehicle 10.

The traction battery pack 18 may be secured to an underbody 20 of the electrified vehicle 10. However, the traction battery pack 18 could be located elsewhere on the electrified vehicle 10 within the scope of this disclosure.

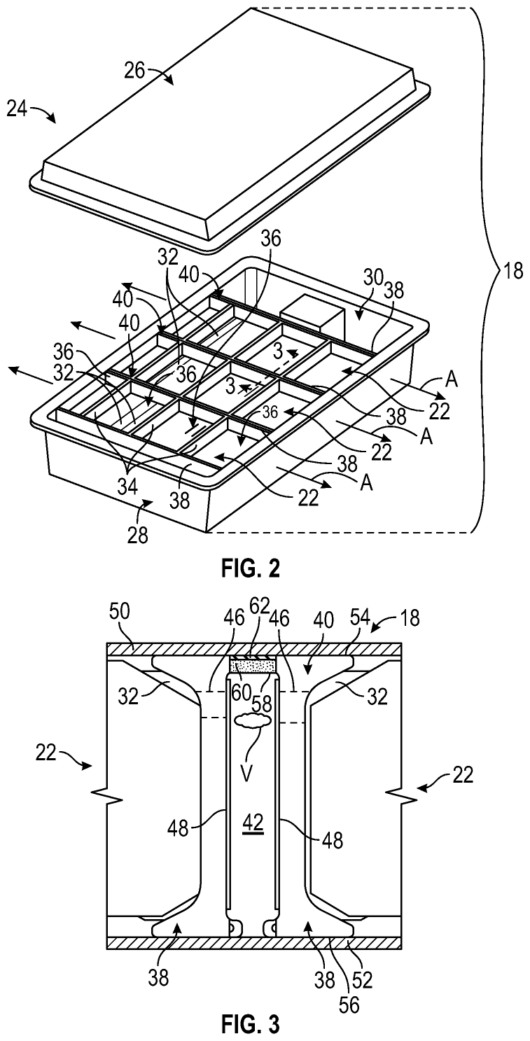

FIGS. 2 and 3 further illustrates details associated with the traction battery pack 18 of the electrified vehicle 10. The traction battery pack 18 may include a plurality of cell stacks 22 housed within an interior area 30 of an enclosure assembly 24. The enclosure assembly 24 of the traction battery pack 18 may include an enclosure cover 26 and an enclosure tray 28. The enclosure cover 26 may be secured (e.g., bolted, welded, adhered, etc.) to the enclosure tray 28 to provide the interior area 30 for housing the cell stacks 22 and other battery internal components of the traction battery pack 18.

Each cell stack 22 may include a plurality of battery cells 32. The battery cells 32 of each cell stack 22 may be stacked side-by-side relative to one another along a cell stack axis A. The battery cells 32 store and supply electrical power for powering various components of the electrified vehicle 10. Although a specific number of the cell stacks 22 and battery cells 32 are illustrated in the various figures of this disclosure, the traction battery pack 18 could include any number of the cell stacks 22, with each cell stack 22 having any number of individual battery cells 32.

In an embodiment, the battery cells 32 are lithium-ion pouch cells. However, battery cells having other geometries (cylindrical, prismatic, etc.) and/or chemistries (nickel-metal hydride, lead-acid, etc.) could alternatively be utilized within the scope of this disclosure.

One or more dividers 34 may be arranged along the respective cell stack axis A of each cell stack 22. The dividers 34 may compartmentalize each cell stack 22 into two or more groupings or compartments 36 of battery cells 32. Each compartment 36 may hold one or more of the battery cells 32 within one of the cell stacks 22. In an embodiment, the battery cells 32 of each cell stack 22 are held within one of four compartments 36. However, other configurations, including configurations that utilize a greater or fewer number of compartments 36, could be used within the scope of this disclosure.

The battery cells 32 of each cell stack 22 may be arranged between a pair of cross-member beams 38. The cross-member beams 38 may be configured to hold the battery cells 32 and at least partially delineate the cell stacks 22.

Immediately adjacent-cross member beams 38 may established a cross-member assembly 40 disposed between adjacent cell stacks 22 of the traction battery pack 18. The cross-member assemblies 40 may be configured to transfer a load applied to a side of the electrified vehicle 10, for example. Each cross-member beam 38 of the cross-member assemblies 40 may be a structural beam that can help accommodate tension loads from battery cell 32 expansion and compression loads. The cross-member assemblies 40 are therefore configured to increase the structural integrity of the traction battery pack 18.

The cross-member assembles 40 may also establish a battery pack venting system for communicating battery cell vent byproducts V from the traction battery pack 18 during a battery thermal event. For example, the cross-member assemblies 40 may establish venting passageways 42 (best shown in FIG. 3) that communicate the battery cell vent byproducts V from the cell stacks 22 toward a position where the battery cell vent byproducts can be expelled from the traction battery pack 18.

Each cross-member beam 38 of the cell stack 22 may include a plurality of vent openings 46 for communicating the battery cell vent byproducts V through the beams and into the venting passageway 42. The vent openings 46 thus provide a path for the battery cell vent byproducts V to move through the cross-member beams 38 and into the venting passageways 42 as required during a venting event.

When the battery cells 32 of the cell stack 22 are not venting, the vent openings 46 may be covered by a sectioned membrane 48. A pressure differential increase associated with one or more of the battery cells 32 venting can rupture a local section of the sectioned membrane 48, thereby allowing the battery cell vent byproducts V to pass through the vent openings 46 into the venting passageway 42. The local sections of the sectioned membrane 48 may locally break away when the battery cell(s) 32 experiences the thermal event to release the battery cell vent byproducts V into the venting passageway 42.

In the exemplary embodiment illustrated in FIG. 3, first and second adjacent cross-member beams 38 may establish a first side and a second side, respectively, of the venting passageway 42 of the cross-member assembly 40. Further, a vertically upper side of the venting passageway 42 may be established by an upper enclosure structure 50, and a vertically lower side of the venting passageway 42 may be established by a lower enclosure structure 52. In an embodiment, the upper enclosure structure 50 is part of the enclosure cover 26 of the enclosure assembly 24, and the lower enclosure structure 52 is part of the enclosure tray 28 of the enclosure assembly 24. However, in other implementations, one or both of the upper and lower enclosure structures 50, 52 may be an intermediate structure (e.g., a heat exchanger plate) positioned vertically between the venting passageway 42 and the enclosure cover 26 and/or vertically between the venting passageway 42 and the enclosure tray 28 for establishing the vertically upper side and the vertically lower side, respectively, of the venting passageway 42. Vertical and horizontal, for purposes of this disclosure, are with reference to ground and a general orientation of traction battery pack 18 when installed within the electrified vehicle 10 of FIG. 1.

The cross-members beams 38 may further include an upper plateau 54 and a lower base 56. When positioned within the enclosure assembly 24 of the traction battery pack 18 in the manner shown in FIG. 3, the upper plateau 54 may interface with the upper enclosure structure 50, and the lower base 56 may interface with the lower enclosure structure 52.

In an embodiment, the cell stacks 22, the cross-member assemblies 40, and the respective venting passageways 42 extend longitudinally in a cross-vehicle direction. However, other configurations are further contemplated within the scope of this disclosure.

One or more thermal barriers 58 may be positioned within the venting passageway 42. Each thermal barrier 58 may be a single-piece structure or a multi-layered sandwich structure that is configured to shield the upper enclosure structure 50 and/or the lower enclosure structure 52 from thermal energy associated with the battery cell vent byproducts V and may further be configured to slow or even prevent thermal propagation from cell stack 22-to-cell stack 22.

Each thermal barrier 58 may include a thermally resistant material 60. In an embodiment, the thermally resistant material 60 may include mica, aerogel materials, refractory ceramic fibers, etc. However, other materials or combinations of materials could with utilized to provide the thermally resistant material 60 within the scope of this disclosure.

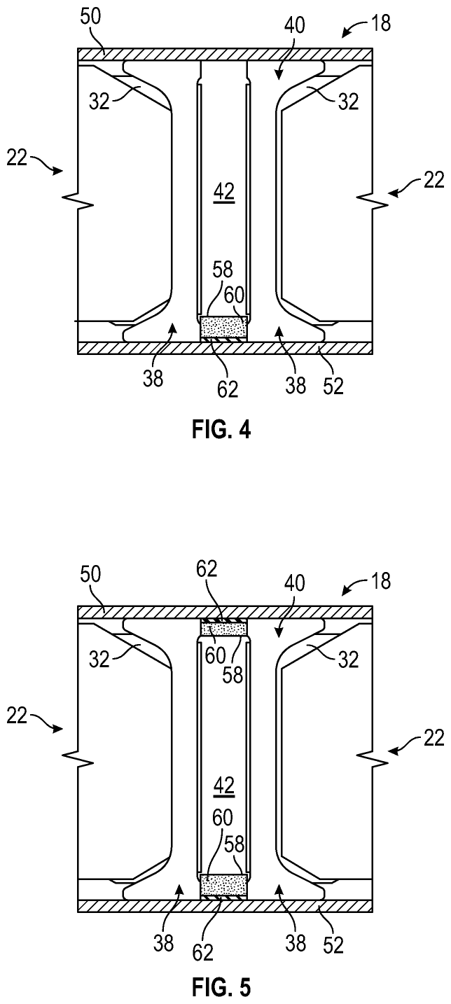

One or more strips of the thermal barrier 58 may be secured to the upper enclosure structure 50 (see FIG. 3), the lower enclosure structure 52 (see FIG. 4), or both (see FIG. 5). An adhesive 62 may be utilized to secure the thermal barrier 58 in place relative to the upper enclosure structure 50 and/or lower enclosure structure 52. The adhesive 62 may be an epoxy based adhesive or a urethane based adhesive, for example.

Once the thermal barrier 58 is secured relative to the upper enclosure structure 50 and/or the lower enclosure structure 52, the thermal barrier 58 may be axially between the adjacent cross-member beams 38. At this position, the thermal barrier 58 may substantially protect the upper enclosure structure 50 and/or the lower enclosure structure 52 from heat and prevent thermal energy from moving from cell stack 22-to-cell stack 22 at the sealed interface between the thermal barrier 58 and the upper enclosure structure 50 and/or lower enclosure structure 52 during a battery thermal event.

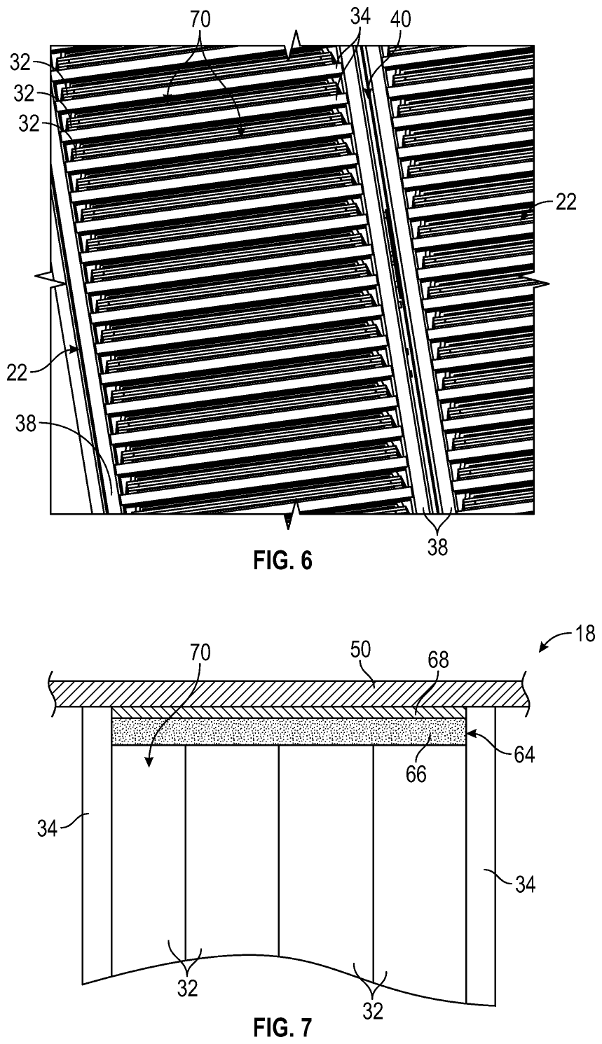

Referring to FIGS. 6-7, each cell stack 22 may include a plurality of cell packets 70. The cell packets 70 may be separated from one another by the dividers 34 and may each include a plurality of battery cells 32. The number of battery cells 32 within each cell packet 70 is not intended to limit this disclosure.

A thermal barrier 64 may be positioned over top of each cell packet 70. The thermal barriers 64 may thus be positioned between the battery cells 32 of each cell packet 70 and the upper enclosure structure 50. The thermal barriers 64 may fill the void spaces between the battery cells 32 and the upper enclosure structure 50 and protect the upper enclosure structure 50 from thermal energy associated with the battery vent byproducts V during a battery thermal event. Notably, the thermal barriers 64 are not shown in FIG. 6 in order to better visualize the cell packets 70.

Each thermal barrier 64 may include a thermally resistant material 66. In an embodiment, the thermally resistant material 66 may include mica, aerogel materials, refractory ceramic fibers, etc. However, other materials or combinations of materials could with utilized to provide the thermally resistant material 66 within the scope of this disclosure.

One or more strips of the thermal barrier 64 may be secured to the upper enclosure structure 50. An adhesive 68 may be utilized to secure the thermal barrier 64 in place relative to the upper enclosure structure 50. The adhesive 68 may be an epoxy based adhesive or a urethane based adhesive, for example.

The exemplary traction battery packs of this disclosure include venting passageways equipped with thermal barriers. The thermal barriers may protect surrounding structures from heat and significantly slow or even prevent cell stack-to-cell stack transfers of a battery thermal event.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A traction battery pack, comprising:
a first cross-member beam that supports a first cell stack;
a second cross-member beam that supports a second cell stack;
a venting passageway disposed between the first cross-member beam and the second cross-member beam; and
a thermal barrier arranged within the venting passageway.

2. The traction battery pack as recited in claim 1, wherein the first cross-member beam and the second cross-member beam establish a cross-member assembly arranged between the first cell stack and the second cell stack.

3. The traction battery pack as recited in claim 1, wherein the first cell stack is supported between the first cross-member beam and a third cross-member beam, and the second cell stack is supported between the second cross-member beam and a fourth cross-member beam.

4. The traction battery pack as recited in claim 1, wherein the thermal barrier is positioned to interface with an upper enclosure structure of the traction battery pack at a vertically upper side of the venting passageway.

5. The traction battery pack as recited in claim 4, comprising an adhesive disposed between the upper enclosure structure and the thermal barrier.

6. The traction battery pack as recited in claim 1, comprising a second thermal barrier positioned to interface with a lower enclosure structure of the traction battery pack at a vertically lower side of the venting passageway.

7. The traction battery pack as recited in claim 1, wherein the thermal barrier is positioned to interface with a lower enclosure structure of the traction battery pack at a vertically lower side of the venting passageway.

8. The traction battery pack as recited in claim 7, comprising an adhesive disposed between the lower enclosure structure and the thermal barrier.

9. The traction battery pack as recited in claim 1, wherein the thermal barrier includes a thermally resistant material.

10. The traction battery pack as recited in claim 9, wherein the thermally resistant material includes mica, aerogel materials, or refractory ceramic fibers.

11. The traction battery pack as recited in claim 1, comprising a second thermal barrier arranged between the first cell stack or the second cell stack and an upper enclosure structure of the traction battery pack.

12. The traction battery pack as recited in claim 11, comprising an adhesive disposed between the upper enclosure structure and the second thermal barrier.

13. A traction battery pack, comprising:
an enclosure assembly establishing an interior area;
a first cell stack housed within the interior area and including a first cross-member beam;
a second cell stack housed within the interior area and including second cross-member beam;
a venting passageway disposed between the first cross-member beam and the second cross-member beam;
a first thermal barrier arranged within the venting passageway; and
a second thermal barrier arranged over top of the first cell stack or the second cell stack.

14. The traction battery pack as recited in claim 13, wherein the first thermal barrier establishes a first sealed interface relative to an upper enclosure structure of the traction battery pack at a vertically upper side of the venting passageway.

15. The traction battery pack as recited in claim 14, comprising an adhesive disposed between the upper enclosure structure and the first thermal barrier.

16. The traction battery pack as recited in claim 14, wherein the second thermal barrier establishes a second sealed interface relative to the upper enclosure structure.

17. The traction battery pack as recited in claim 16, comprising an adhesive disposed between the upper enclosure structure and the second thermal barrier.

18. The traction battery pack as recited in claim 13, wherein each of the first thermal barrier and the second thermal barrier includes a thermally resistant material.

19. The traction battery pack as recited in claim 18, wherein the thermally resistant material includes mica, aerogel materials, or refractory ceramic fibers.

20. The traction battery pack as recited in claim 13, comprising a third thermal barrier arranged within the venting passageway.
